(19) United States
(12) Patent Application Publication
(10) Pub. No.: US 2010/0108267 A1
(43) Pub. Date: May 6, 2010

(54) Tape dispenser

(76) Inventor: Wu-Hsiung Chung, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,476

(22) Filed: Dec. 30, 2008

(30) Foreign Application Priority Data
Oct. 31, 2008 (TW) 097219441

(51) Int. Cl. B32B 37/00

(52) U.S. Cl. 156/527

(57) ABSTRACT

A tape dispenser includes a body, a tape holder and a cutter holder respectively mounted in two ends of the body to hold a tape or a cutter blade, and an adhesion member disposed between the cutter holder and the cutter blade for sucking and securing the lead end of the tape after each tape dispensing operation and cut of the dispensed tape by the cutter blade.

### BACKGROUND OF THE INVENTION

The present invention relates to tape dispensers and more particularly, to such a tape dispenser, which can suck and secure the lead end of the tape after each tape dispensing operation, facilitating tape dispensing

FIG. 1 illustrates a tape dispenser according to the prior art. According to this design, the tape dispenser 10 comprises a grip 11, a transverse plate 12 fixedly mounted on one end (the top end) of the grip 11, a connection frame 15 fixedly connected to one lateral side of the transverse plate 12, a tape holder 13 provided at one end of the connection frame 15 for holding a tape 101, a cutter holder 18 provided at the other end of the connection frame 15 and holding a cutter blade 19, a roller 17 and a tension plate 16 spaced below the cutter holder 18 and respectively fastened to the connection frame 15 and/or the transverse plate 12.

When a tape 101 is mounted on the tape holder 13, the lead end 103 of the tape 101 is extended over the tension plate 16 to the surface of the roller 17. By means of the roller 17, the user can move the tape dispenser 10 over the product to be sealed, dispensing the tape 101 to the surface of the product and then cut off the dispensed part of the tape by means of the cutter blade 19.

The tape 101 has one side glued and the other side maintained in plain manner. The non-glue side of the tape 101 is kept facing the roller 17. After each tape dispensing operation, the lead end 103 of the tape 101 may fly in the air and may be adhered to an external body accidentally, bringing inconvenience to the user. In this case, the user needs to cut off a certain part of the lead end of the tape 101, resulting in waste of tape.

The surface part of the cutter holder 18 that is disposed adjacent to the roller 17 may be used to secure the lead end 103 of the tape 101 after each tape dispensing operation. However, because the cutter holder 18 is made of metal, the material property of the cutter holder 18 does not provide a satisfactory suction power to secure the lead end 103 of the tape 101.

Therefore, it is desirable to provide a tape dispenser that eliminates the aforesaid problem.

### SUMMARY OF THE PRESENT INVENTION

It is, therefore, the primary object of the present invention to provide a tape dispenser, which has an adhesion member provided at a part of the surface of the cutter holder to suck and secure the lead end of the tape after each tape dispensing operation, facilitating a next tape dispensing operation.

It is another object of the present invention to provide a tape dispenser, which uses an adhesion member to suck and secure the lead end of the tape after each tape dispensing operation, avoiding waste of the tape.

To achieve these and other objects of the present invention, a tape dispenser comprises a body, a tape holder mounted in one end of the body and supporting a tape, a cutter holder mounted in the other end of the body and holding a cutter blade for cutting off the tape to have the tape provide a lead end, and an adhesion member mounted on the cutter holder and exposed to the outside for sucking and securing the lead end of the tape.

### BRIEF DESCRIPTION OF THE DRAWINGS

FIG. 1 is an elevational view of a tape dispenser according to the prior art.

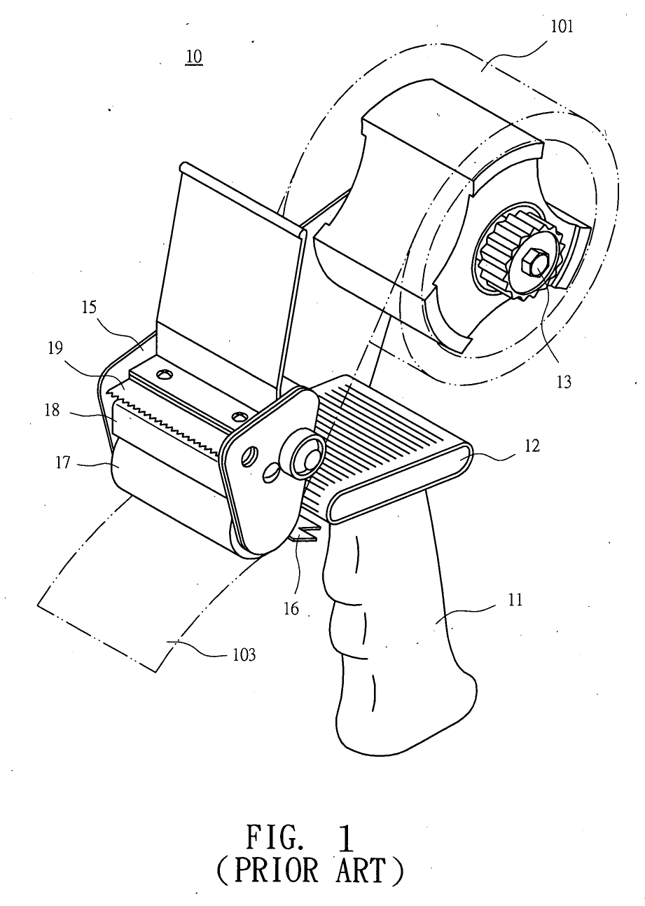

FIG. 2 is an exploded view of a tape dispenser in accordance with the present invention.

FIG. 3 is a schematic drawing of the present invention, showing a status of use of the tape dispenser.

FIG. 4 illustrates an alternate form of the tape dispenser according to the present invention.

FIG. 5 illustrates another alternate form of the tape dispenser according to the present invention.

FIG. 6 illustrates still another alternate form of the tape dispenser according to the present invention.

FIG. 7 illustrates still another alternate form of the tape dispenser according to the present invention.

FIG. 8 illustrates still another alternate form of the tape dispenser according to the present invention.

### DETAILED DESCRIPTION OF THE PREFERRED EMBODIMENTS

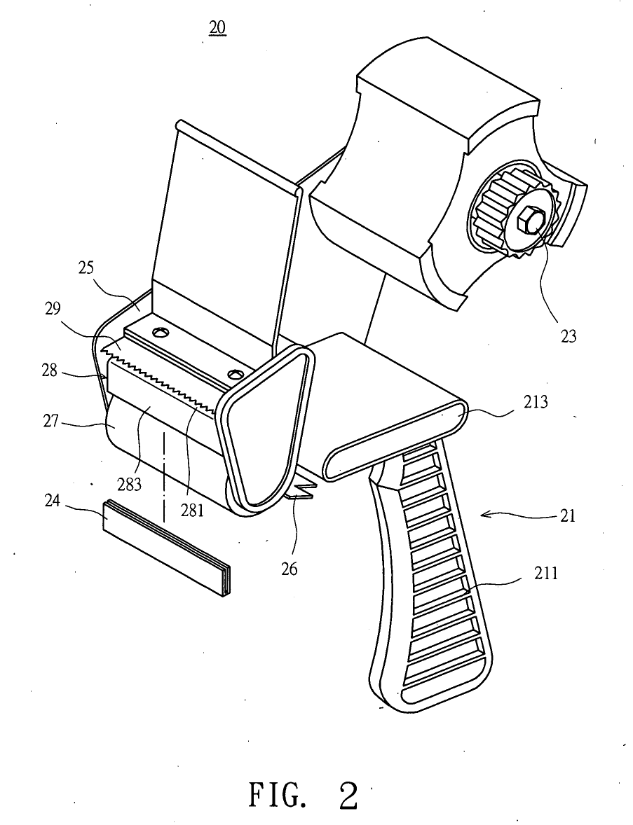

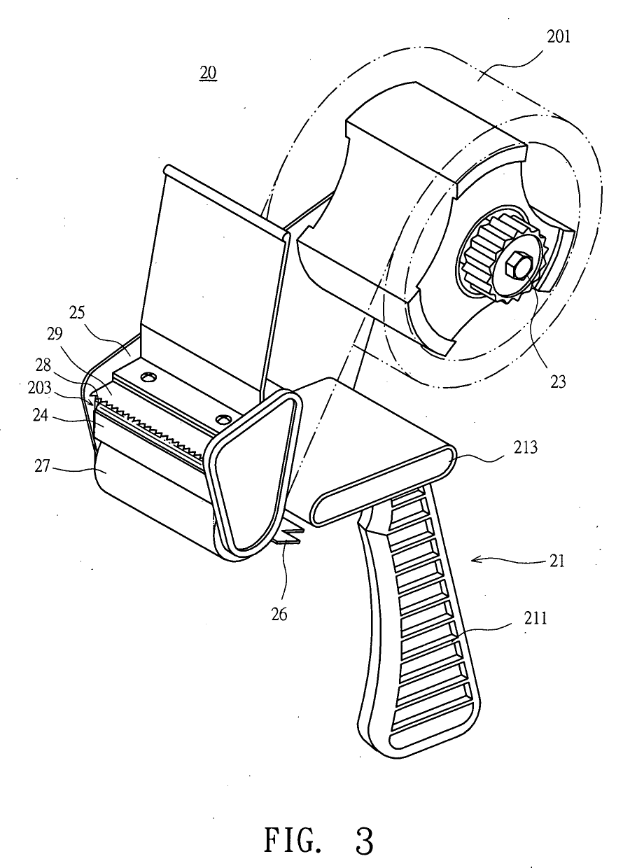

Please refer to FIGS. 2 and 3, a tape dispenser 20 in accordance with a first embodiment of the present invention is a handheld type, comprising a body 21. The body 21 comprises a grip 211, and a transverse plate 213. The transverse plate 213 is fixedly mounted on one end (for example, the top end) of the grip 211. The tape dispenser 20 further comprises a connection frame 25 fixedly fastened to one lateral side of the transverse plate 213, a tape holder 23 provided at one end of the connection frame 25, a cutter holder 28 provided at the other end of the connection frame 25, a cutter blade 29 fixedly mounted in the cutter holder 28, a roller 27 and/or a tension plate 26 affixed to the connection frame 25 and/or the transverse plate 213 and spaced below the cutter blade 29, and an adhesion member 24 affixed to the cutter holder 28 and kept between the roller 27 and the cutter blade 29 and partially exposed to the outside.

When using the tape dispenser 20 to dispense a tape 201, the tape 201 is supported on the tape holder 23 with one end (the lead end) 203 thereof extending over the tension plate 26 and the surface of the roller 27 to the adhesion member 24. At this time, the user can hold the tape dispenser 20 and attach the tape 201 to the surface of the product to be adhered, and then move the tape dispenser 20 over the surface of the product to rotate the roller 27 and to simultaneously apply the tape 201 to the surface of the product. After dispensing of the tape 201, the tape 201 is cut off by means of the cutter blade 29.

After cut-off, the lead end 203 of the tape 201 and adhered to the surface of the adhesion member 24 and/or the roller 27, avoiding flying.

Because the lead end 203 of the tape 201 is adhered to the surface of the adhesion member 24 and/or the roller 27 and will not fly in the air, the user can dispense the tape 201 in the next dispensing operation or cut the tape 201 conveniently. Further, because the lead end 203 of the tape 201 does not fly in the air, the lead end 203 will not be adhered to a surface of an external object accidentally, maintaining its adhesion function. Therefore, when applying the tape 201, it is not necessary to cut off the lead end 203 before application, avoiding waste.

According to this first embodiment, the cutter holder 28 has a horizontal portion 281 and a vertical portion 283. The vertical portion 283 is disposed at one side of the horizontal portion 281. The horizontal portion 281 supports the cutter blade 29. The vertical portion 283 supports the adhesion member 24. The adhesion member 24 has a mounting layer affixed to the vertical portion 283. Further, the mounting layer of the adhesion member can be fastened to the vertical portion 283 by means of a glue (not shown) and/or tight fit. According to this embodiment, the adhesion member 24 is made in the form of a cap tightly capped on the vertical portion 283.

The adhesion member 24 can be made of any material capable of adhering the tape 201, such as rubber, plastics, silicon rubber, compound polymers, sticker board, and/or their combination. According to test, using a rubber or plastic compound material to make the adhesion member 24 provides a static storage function that shows superiority to the metal vertical portion 283 in sucking and securing the lead end 203 of the tape 201. The adhesion member 24 can adhere an OPP/PVC/PE/PP-based adhesive tape, or any of a variety of other special tapes, such as packing tapes, industry tool tape, or insulation tape.

The aforesaid sticker board for the adhesion member 24 can be any sticker board or sticker agent obtained from 3M™, or any commercial self-adhesive repositionable board, Post-it, Yes-Poster® that can be used to repeatedly secure a tape.

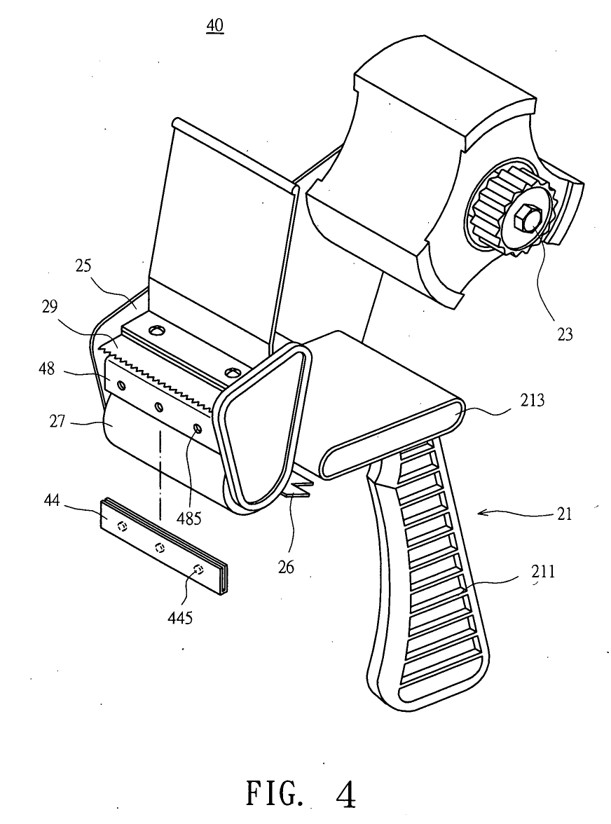

FIG. 4 illustrates an alternate form of the tape dispenser according to the present invention. According to this embodiment, the cutter holder 48 of the tape dispenser 40 has a plurality of recessed locating holes 485, and the adhesion member 44 has a plurality of raised positioning portions 445 respectively engaged into the recessed locating holes 485 to such and secure the adhesion member 44 to the cutter holder 48. Alternatively, the recessed locating holes 485 can be formed on the adhesion member 44, and the raised positioning portions 445 can be formed on the cutter holder 48 for engagement with the recessed locating holes 485 to such and secure the adhesion member 44 to the cutter holder 48.

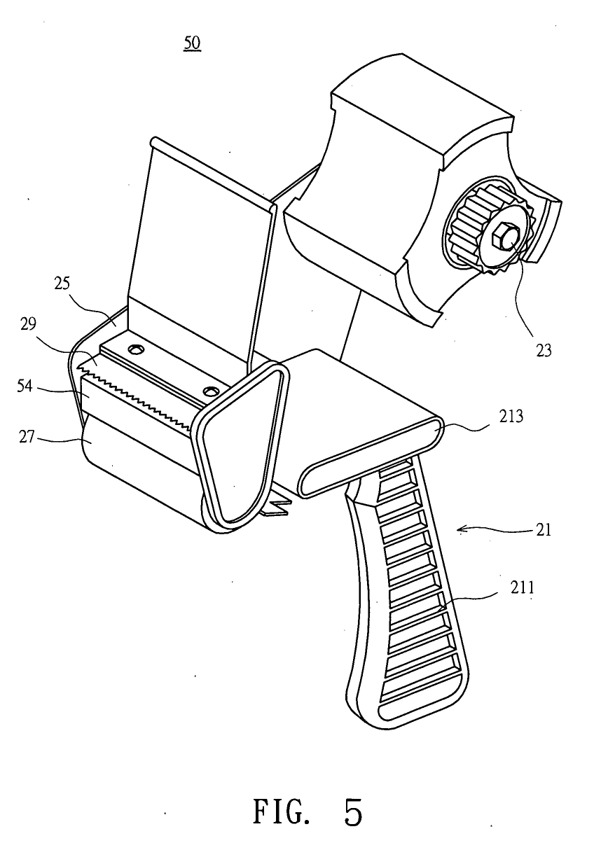

FIG. 5 illustrates another alternate form of the tape dispenser according to the present invention. According to this embodiment, the cutter holder 54 of the tape dispenser 50 is a single piece of the combination of the cutter holder and adhesion member of the aforesaid embodiment (for example, the embodiment shown in FIG. 2), i.e., the cutter holder 54 is made by using the material of the aforesaid adhesion member 28 to make the shape of the aforesaid cutter holder 24. The cutter blade 29 is directly affixed to the cutter holder 54. The other part of the surface of the cutter holder 54 that exposes to the outside of the cutter blade 29 can be used to such and secure the tape's lead end 203.

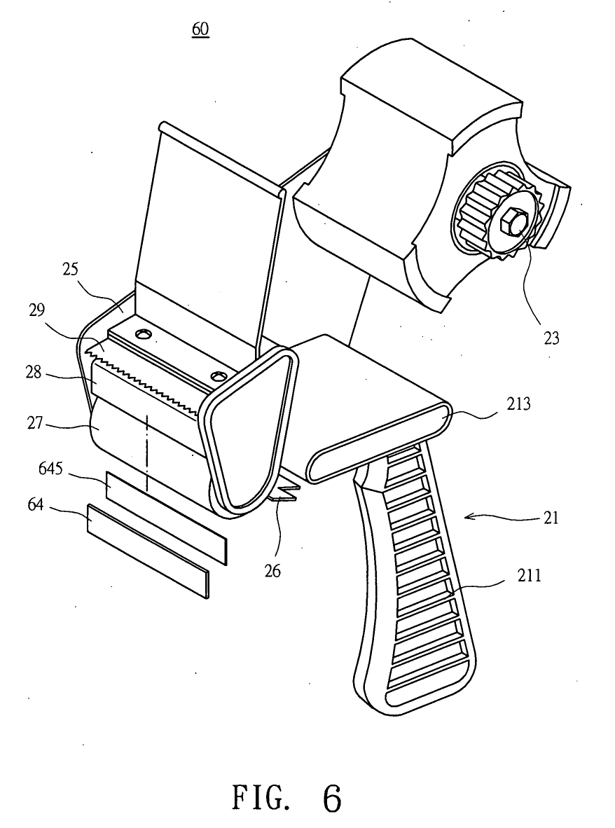

FIG. 6 illustrates still another alternate form of the tape dispenser according to the present invention. According to this embodiment, the adhesion member 64 of the tape dispenser 60 is a sheet member affixed to a part of the surface of the cutter holder 28 by means of positioning means 645, such as glue and/or a raised positioning portion/recessed locating hole for sucking and securing the lead end of the tape mounted in the tape dispenser 60.

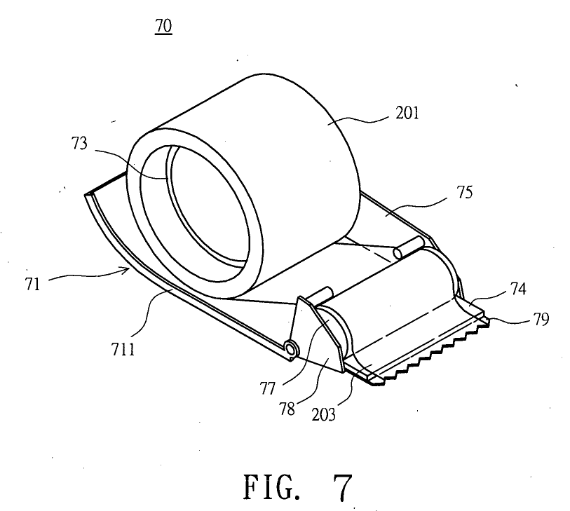

FIG. 7 illustrates still another alternate form of the tape dispenser according to the present invention. According to this embodiment, the tape dispenser 70 is a handheld type tape dispenser comprising a body 71. The body 71 comprises a grip 711, connection frame 75 fixedly fastened to one lateral side of the grip 711, a tape holder 73 provided at one end of the connection frame 75, a cutter holder 88 provided at the other end of the connection frame 75, a cutter blade 79 fixedly mounted in the cutter holder 78, an adhesion member 74 mounted on the surface of the cutter holder 78, and a roller 77 pivotally mounted in the cutter holder 78 between the adhesion member 74 and the tape holder 73.

When a tape 201 is mounted on the tape holder 73, the lead end 203 of the tape extends over the roller 77 and secured to the adhesion member 74. After each dispensing operation, the lead end 203 of the tape 201 is kept adhered to the adhesion member 74 and/or the surface of the roller 77, convenient for a next dispensing operation.

The cutter blade 79 can be formed integral with a part of the cutter holder 78, i.e., the cutter holder 78 and the cutter blade 79 are integrated into one single piece. The adhesion member 74 is directly affixed to a part of the surface of the cutter blade 79.

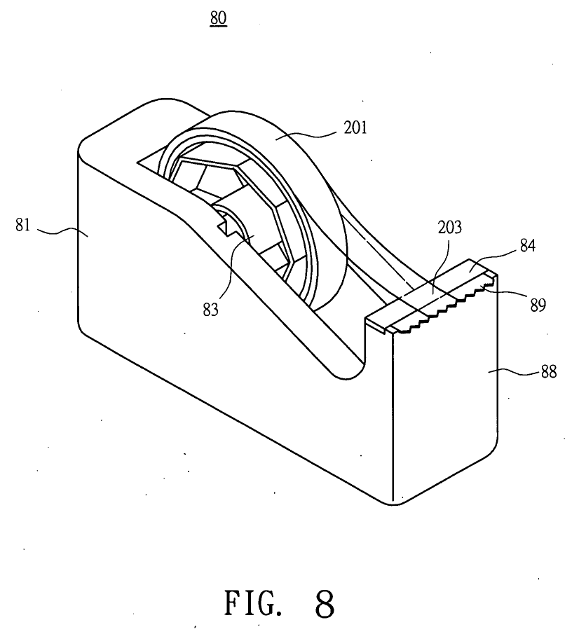

FIG. 8 illustrates still another alternate form of the tape dispenser according to the present invention. According to this embodiment, the body 81 of the tape dispenser 80 is shaped like a vessel, having a tape holder 83 mounted in its one end to hold a tape 201 and a cutter holder 88 mounted in its other end to hold a cutter blade 89 and an adhesion member 84.

After each dispensing operation, the lead end 203 of the tape 201 is secured to the surface of the adhesion member 84, convenient for a next dispensing operation.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tape dispenser, comprising:
a body;
a tape holder mounted in one end of said body and supporting a tape;
a cutter holder mounted in an opposite end of said body and holding a cutter blade for cutting off said tape to have said tape provide a lead end; and
an adhesion member mounted on said cutter holder, said adhesion member having an exposed surface for sucking and securing said lead end of said tape.

2. The tape dispenser as claimed in claim 1, wherein said body comprises:
a grip, said grip having a transverse plate fixedly mounted on one side thereof;
a connection frame fixedly mounted on one lateral side of said transverse plate, said connection frame having one end thereof connected to said tape holder and an opposite end thereof connected to said cutter holder; and
a roller pivotally mounted in one end of said connection frame adjacent to said cutter holder and spaced below said cutter holder such that said adhesion member is disposed between said roller and said cutter blade.

3. The tape dispenser as claimed in claim 2, wherein said cutter holder comprises a horizontal portion and a vertical portion, said horizontal portion holding said cutter blade, said vertical portion holding said adhesion member.

4. The tape dispenser as claimed in claim 1, wherein said adhesion member is a cap member tightly capped on a part of said cutter holder.

5. The tape dispenser as claimed in claim 1, wherein said adhesion member is an adhesion sheet member comprising a mounting layer for fastening to said cutter holder.

6. The tape dispenser as claimed in claim 1, wherein said adhesion member comprises mounting means for fastening to said cutter holder, said mounting means being selected from one of a glue, raised positioning means/recessed positioning means, a tight-fitting engagement means and their combinations.

7. The tape dispenser as claimed in claim 6, wherein said raised positioning means/recessed positioning means are selectively provided at said cutter holder and said adhesion member so that said adhesion member is fastened to said cutter holder subject to engagement between said raised positioning means and said recessed positioning means.

8. The tape dispenser as claimed in claim 1, wherein said adhesion member is prepared from a material group of rubber, plastics, silicon rubber, adhesion compound material, sticker board and their combinations.

9. The tape dispenser as claimed in claim 1, wherein said adhesion member is formed integral with a part of said cutter holder.

10. The tape dispenser as claimed in claim 1, wherein said cutter blade is formed integral with a part of said cutter holder.

11. The tape dispenser as claimed in claim 1, wherein said body comprising:
a grip;
a connection frame fixedly mounted on one side of said grip, said connection frame having one end thereof connected to said tape holder and an opposite end thereof connected to said cutter holder; and
a roller pivotally mounted in one end of said connection frame adjacent to said cutter holder and spaced between said cutter holder and said tape holder such that said adhesion member is disposed between said roller and said cutter blade.

12. The tape dispenser as claimed in claim 11, wherein said cutter blade is formed integral with a part of said cutter holder.

13. The tape dispenser as claimed in claim 11, wherein said adhesion member is an adhesion sheet member comprising mounting means for fastening to said cutter holder.

14. The tape dispenser as claimed in claim 13, wherein said mounting means is selected from one of a glue, raised positioning means/recessed positioning means, a tight-fitting engagement means and their combinations.

15. The tape dispenser as claimed in claim 14, wherein said raised positioning means/recessed positioning means are selectively provided at said cutter holder and said adhesion member so that said adhesion member is fastened to said cutter holder subject to engagement between said raised positioning means and said recessed positioning means.

16. The tape dispenser as claimed in claim 11, wherein said adhesion member is prepared from a material group of rubber, plastics, silicon rubber, adhesion compound material, sticker board and their combinations.

17. The tape dispenser as claimed in claim 11, wherein said body is made in one of the forms of handheld type for handheld application and table-top design for use on a table.
